(19) United States
(12) Patent Application Publication
(10) Pub. No.: US 2009/0297913 A1
(43) Pub. Date: Dec. 3, 2009

(54) Nanostructure-Enhanced stereo-electrodes for fuel cells and biosensors

(75) Inventors: Guigen Zhang, Bogart, GA (US); Venkataramani Anandan, Croton on Hudson, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The University of Georgia Research Foundation, Inc., Athens, GA (US)

(21) Appl. No.: 12/382,861

(22) Filed: Mar. 25, 2009

Related U.S. Application Data
(60) Provisional application No. 61/039,347, filed on Mar. 25, 2008.

(51) Int. Cl. H01M 8/10; H01M 8/00; H01M 4/86; H01M 2/02; G01N 27/26; C25D 5/02

(52) U.S. Cl. 429/33; 429/12; 429/40; 429/34; 204/403.01; 205/122; 977/742

(57) ABSTRACT

This application provides nanostructure-enhanced stereo-electrodes. The application also provides novel ways to manufacture nanostructure-enhanced electrodes. In some embodiments, the invention also provides methods of use for devices equipped with the nanostructure-enhanced stereo-electrodes.

### CROSS REFERENCE TO RELATED APPLICATIONS

This application claims the benefit of U.S. provisional application 61/039,347, filed Mar. 25, 2008, which is incorporated herein by reference in its entirety.

### STATEMENT REGARDING FEDERALLY-SPONSORED RESEARCH

Part of the work performed during development of this invention utilized U.S. Government funds under ECS 0304340 awarded by the National Science Foundation. Therefore, the U.S. Government has certain rights in this invention.

### BACKGROUND OF THE INVENTION

1. Field of the Invention

The present invention is directed to nanostructure-enhanced stereo-electrodes, their methods of use, and processes for making nanostructure-enhanced stereo-electrodes.

2. Background Art

Nanotechnology has been identified as a key technology for the 21 st century. This technology is centered on an ability to fabricate various devices on scale as small as a few billionths of a meter. There are many advantages of fabricating nanoscale devices. In the simplest case, such devices are much smaller than the current commercial devices and so provide opportunities for increased packing densities, lower power consumption and higher speeds. In addition, such small devices can have fundamentally different properties to those fabricated on a larger scale, and this then provides an opportunity for completely new device applications.

Nanotechnology has the potential to create many new materials and devices with wide-ranging applications. It is an object of the invention to provide methods of preparing nanoscale structures and/or devices formed therefrom which can find useful applications in electronics and medicine.

### BRIEF SUMMARY OF THE INVENTION

The present invention provides nanostructure-enhanced stereo-electrodes and devices containing such structures. In one aspect, the present invention provides a nanostructure-enhanced stereo-electrode comprising a substantially flat support base and nanostructures attached to the base. In one embodiment, the surface of the nanostructures is made catalytically active. In one embodiment, the nanostructures are porous nanotubes. In certain embodiments, the nanotubes are filled with an ion-conducting electrolyte. In another embodiment, the nanostructures are nanopillars. In yet another embodiment, the nanostructures are nanoparticles. In other embodiments, the present invention discloses processes for making nanostructure-enhanced stereo-electrodes and methods of their use.

In one aspect of the present invention, the nanostructure-enhanced stereo-electrodes are incorporated into biosensors, as such biosensors provide a much greater surface area for catalytic conversion and electron transfer. In one embodiment, the biosensor comprises a three-electrode set of nanopillar-enhanced working, counter, and reference electrodes, surrounded by an array of nanopillars serving as the “fencing pillars”. In another embodiment, the biosensor comprises nanopillar-enhanced stereo-electrodes standing on flat interdigitated microelectrodes. The nanoscale design of the biosensors described herein allows for much greater optimization of the sensors for catalytic conversion, electron transfer, and mass transport.

Another aspect of the present invention describes nanoscale ion-conducting electrolyte structures. In one embodiment, the ion-conducting electrolyte structure comprises a 3D interconnected electrolytic network formed by porous nanotubes filled with an ion-conducting electrolyte.

In another aspect, the present invention provides electrochemical conversion devices. In one embodiment, the electrochemical conversion device is a fuel cell, which comprises the nanotube-enhanced electrodes, and at least an anode and a cathode. In one embodiment, the porous nanotubes are filled with an ion-conducting electrolyte. Unlike the traditional 2D layer-structure design, the 3D stereo-structure of the present invention provides unprecedented amount of surfaces for ionization, deionization, and the transport of ions and electrons in a most efficient and effective three-phase-contact manner.

In another aspect, the present invention provides processes for fabricating nanostructure-enhanced stereo-electrodes. In some embodiments, the electrode is fabricated by first coating a silicon wafer with several thin layers of metallic film and anodizing the top layer to form a nanoporous template, followed by electrodeposition of metal nanostructures and removal of the template. In one embodiment, the nanostructures are made porous by de-alloying. In another embodiment, the nanostructures are filled with an electrolyte. In yet another embodiment, electrolyte-filled nanostructures are stacked on top of each other.

Another aspect of the present invention provides methods for using the devices containing nanostructure-enhanced stereo electrodes described herein. In one embodiment, the biosensors of the present invention can be used for remote detection of biological warfare agents (i.e., anthrax). In another embodiment, the biosensors with the integrated micro/nano structures fabricated by the process of the present invention can be used for in-vitro and ex-vivo monitoring of bioanalytes. In some embodiment, the fuel cells of the present invention can be used as power sources in remote locations, such as spacecraft and rural locations. In some embodiments, the fuel cells of the present invention can be used as power supplies in vehicles and portable charging docks for small electronics.

### BRIEF DESCRIPTION OF THE DRAWINGS

FIG. 1 provides an illustration of a nanostructure-enhanced stereo-electrode

FIG. 2 illustrates, schematically, a process of developing a micropatterned nanostructure-enhanced catalytic surface.

FIG. 3 illustrates, schematically, a process of developing an electrolyte-filled nanostructure-enhanced stereo electrodes.

FIG. 4a illustrates, schematically, a design of a conventional fuel cell.

FIG. 4b illustrate, schematically, a design for a fuel cell containing nanostructure-enhanced stereo-electrodes.

FIG. 5 illustrates, schematically, a process of hydrogen evolution at a catalyst/electrolyte/electrode junction.

FIG. 6 provides a schematic illustration of a biosensor containing nanostructure-enhanced stereo-electrodes.

FIG. 7 provides a schematic illustration of a microflow channel biosensor containing nanostructure-enhanced stereo-electrodes.

FIG. 8 provides a cyclic voltanogramm for the three nanopillar electrodes and a flat control electrode.

It is understood that the illustrations and figures of the present application are not necessarily drawn to scale and that these figures and illustrations merely illustrate, but do not limit, the present invention.

### DETAILED DESCRIPTION OF THE INVENTION

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### I. Definitions

As used herein, the term “electrode” refers to an electrical conductor used to make contact with a nonmetallic part of an electrical circuit, such as a semiconductor, an electrolyte, or a vacuum. The term “electrical circuit” is understood to mean a closed path formed by interconnection of a variety of electronic components available to the skilled artisan. The term “electrochemical reaction” refers to any chemical reaction that takes place in a solution at the interface of an electron conductor (a metal or a semiconductor) and an ionic conductor (the electrolyte), and that elicits chemical potential by the means of electron transfer between the electrode and the electrolyte or species in solution. The term “reference electrode”, as used herein, refers to an electrode that has a stable and well-known electrode potential. Examples of the reference electrode suitable for this invention include, but are not limited to, a standard hydrogen electrode (SHE), a reversible hydrogen electrode (RHE), a saturated calome electrode (SCE), copper-copper (II) sulfate electrode, and palladium-hydrogen electrode. The term “working electrode” refers to an electrode on which a reduction or oxidation reaction occurs. The term “counter electrode” refers to an auxiliary electrode used to make a connection to the electrolyte so that a current can be applied to the working electrode. A suitable material used for the counter electrode can be any inert material, such as copper, ruthinium, rhodium, palladium, silver, rhenium, osmium, iridium, platinum, gold, graphite, and combinations and alloys thereof.

As used herein, the term “electrochemical conversion device” refers to a device capable of producing an electrical current from energy released by a spontaneous reduction/oxidation reaction. The terms “reduction/oxidation reaction” or “redox reaction” are used interchangeably and refer to all chemical reactions in which atoms have their oxidation number changed.

The term “coating” refers to a complete or partial covering of a surface with a material other than the material already present on the surface. “Functionalization” is used to mean attaching of one or more of a catalytic molecule onto a surface, rendering the surface catalytically active.

As used herein, the term “biosensor” refers to a device for the detection of an analyte that combines a biological component with a physicochemical detector component. The term “analyte” refers to a naturally occurring and/or synthetic compound, which is a marker for a condition (i.e., drug abuse), disease state (i.e., infection disease), disorder (i.e., neurological disorder), or a normal or pathologic process that occurs in a patient (i.e., drug metabolism). An analyte is any substance, including chemical and/or biological agents, that can be measured in an analytical procedure.

As used herein, “vertically standing nanostructures” refers to structures that are substantially vertical in orientation to the support substrate. In certain embodiments, the vertically standing structures are essentially at a 90 degree angle to the support substrate.

For purposes of the present invention, the term “anodization” refers to a process whereby the valve metal in question (e.g., Al, Ti, Cr, Ta, etc.) is converted to its anodically generated oxide in aqueous acidic solution, typically a diprotic acid such as H₂SO₄, oxalic, phosphoric, etc. The term “valve metal” refers to a metal that produces a stable oxide layer, such as aluminum, titanium, tantalum, zirconium, niobium, chromium, etc.

As used herein, the term “microflow-channel” refers to an apparatus of micro-scale dimensions designed for driving a microflow, or a fluid, in microliter amounts. The terms “microscale-interdigitated” or “micro-interdigitated” are used interchangeably, and refer to an arrangement of electrodes, wherein a working electrode is placed next to a detector electrode in an alternating manner. The term “detector electrode” refers to an electrode capable of sensing an electrical current produced as a result of a redox reaction taking place at the working electrode.

### II. Nanostructure-Enhanced Stereo Electrodes

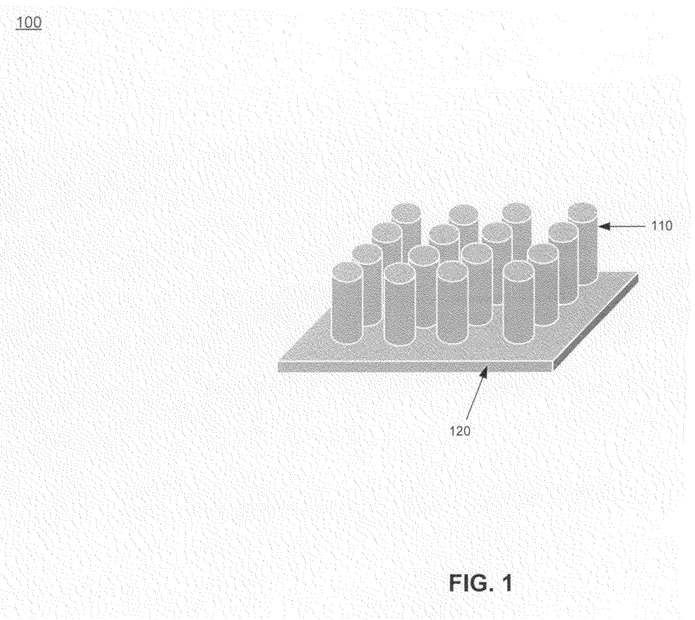

One aspect of the present invention, as illustrated in FIG. 1, provides a nanostructure-enhanced stereo electrode. A nanostructure of the present invention includes, but is not limited to, any nanoscale structure with a length-to-width ratio of about 1 to about 50, preferably about 2 to about 25, more preferably about 3 to about 15.

In one embodiment, the nanostructure of the present invention has an outer diameter in a range of about 40 to about 250 nm. The nanostructure of the present invention can be solid or hollow, porous or non-porous. In one embodiment, the nanostructure is a porous nanotube. In another embodiment, the nanostructure is a non-porous nanopillar. In yet other embodiments, the nanostructure of the present invention is a porous or non-porous nanoparticle. In certain embodiments, the nanostructures of the present invention have an outer diameter in a range of about 120 to about 170 nm. In yet another embodiment, the outer diameter of the nanostructures of the present invention range between about 130 nm and about 160 nm. In one embodiment, the nanostructures of the present invention have an outer diameter of about 150 nm. In one embodiment, the porous nanotubes have an inner diameter in a range of about 20 to about 230 nm. In another embodiment, the porous nanotubes of the present invention have an inner diameter in a range of about 100 to about 150 nm. In yet another embodiment, the inner diameter of the porous nanotubes of the present invention range between about 110 nm and about 140 nm. In one embodiment, the nanostructures of the present invention have an inner diameter of about 120 nm. In some embodiments of the present invention, the height of nanostructures ranges between about 10 nm and about 50 μm. The height of the nanostructures can be uniform or non-uniform. In one embodiment, the nanostructures of the present invention have a uniform height in the range of about 0.1 μm to about 6.8 μm.

In one embodiment, the nanostructure-enhanced stereo-electrode comprises a 3D surface 100 formed by an array of nanostructures 110 standing on a solid flat support base 120. The 3D surface functions as the active surface for electrochemical reactions. The 3D surface of the present invention can be made of any suitable metal. In some embodiments, a suitable metal comprises metals, metal oxides, and alloys. Examples of suitable metal are, but not limited to, gold, silver, platinum, aluminum, aluminum oxide, copper, palladium, or combinations thereof.

Base 120 can be any substantially flat or planar material. In certain embodiments, base 120 is a glass disk or a glass plate. In other embodiments, base 120 is a silicon chip or wafer. In other embodiments, base 120 can be a ceramic or concrete plate that has been manufactured to be substantially flat. Although reference is made above to disks, plates, or chips, it is understood that the nanostructure-enhanced electrodes of the present invention can be formed onto any shaped base 120, so long as that base 120 is substantially flat or planar. The term “substantially flat or planar” as used herein means an active surface that is uniformly flat or planar. It is understood that under today's conventional manufacturing techniques no surface is perfectly flat or planar. Some irregularities on the surface is acceptable.

In one embodiment of the present invention, the porous nanotubes are filled with an ion-conducting electrolyte. The electrolyte of the present invention can be solid or liquid. In certain embodiment, the electrolyte comprises solid electrolytes such as, but not limited to, CsH₂SO₄, NaCl, Ag₂S, AgI, PbCl₂, RbAg₄I₅, or combinations thereof. In one embodiment, the nanotubes are filled with CsH₂SO₄.

In another embodiment, a preferred feature of the invention is to make the outer surface of at least one of the nanostructures catalytically active. In one embodiment, the catalytically active material is a material capable of catalyzing a reduction/oxidation (redox) chemical transformation reaction. In certain embodiments, the outer surface is made catalytically active by coating it with a catalyst. The outer surface can be coated with the catalytic material selected from a metal, metal oxide, or metal alloy. A suitable catalytic material of the present invention comprises metals, metal oxides, and alloys such as, but not limited to, platinum, palladium, rhodium, lead, or combinations thereof.

In certain other embodiments, the outer surface is made catalytically active by functionalizing it with the catalyst. In one embodiment, the catalyst of the present invention is a macromolecule. Examples of the macromolecules include, but are not limited to, any biomolecule capable of changing a reduction/oxidation chemical transformation utilizing any known redox co-factor. One example of a macromolecule suitable for use in the present invention is glucose oxidase.

### III. Methods for Fabricating Nanostructure-Enhanced Stereo-Electrodes

Another aspect of the present invention describes methods for fabricating nanostructure-enhanced stereo-electrodes. A number of techniques can be used to fabricate the nanostructures. Among those techniques chemical vapor deposition technique (CVD), physical vapor deposition technique (PVD), and template-based electrodeposition technique can be used. One of the major disadvantages of nanostructures prepared by CVD or PVD is their inability to sustain the capillary forces generated by the nanostructure-liquid interactions. When vertically aligned nanostructures are exposed to a liquid environment, capillary forces are generated between the vertically aligned nanostructures and the liquid medium. Often, the nanostructures are unable to sustain these forces, leading to their deformation or bunching. As a consequence of such deformations, the magnitude of increase in the surface area is drastically reduced, posing a serious problem for utilization of such nanostructures in aqueous-based biosensors. The present invention overcomes these disadvantages. Nanostructures prepared by the process described herein are formed via metallic bonds, leading to superior mechanical properties. The resulting smooth nanoscopic surface of the nanostructures aids in the minimization of the surface tension, leading to the resistance of the nanostructures to the capillary interaction forces.

In certain embodiments of the present invention, a process for fabricating the nanostructure-enhanced stereo-electrodes comprises:
1) developing a nanoporous template by anodizing a sheet made of first metal,
2) electrodepositing nanostructures, and
3) removing the template.

It is understood that the description herein is but one embodiment for fabricating the nanostructure-enhanced stereo-electrodes. One embodiment of the present invention describes anodization of a valve metal. When a valve metal is anodized in an appropriate acidic electrolyte under controlled conditions, it oxidizes to form a hydrated metal oxide containing a two dimensional organized hexagonal array of cylindrical pores. The pore diameter and the interpore spacing depend primarily on the applied electrical potential and in a secondary fashion on electrolyte pH, temperature, and metal microstructure (grain size).

In this embodiment, a nanoporous template 210 or 320 is prepared from any suitable metal known to those skilled in the art and guided by the teachings herein provided. In some embodiments, a suitable metal of the present invention comprises metals and alloys such as, but not limited to, aluminum, titanium, zinc, magnesium, niobium, or combinations thereof. In one embodiment, the metal used for formation of the nanoporous template is aluminum.

In one embodiment, the template (e.g., Al, Ti, Cr, Ta, etc.) may be created by first coating a flat surface 220 with several thin layers of metal. Examples of the surface suitable for the purposes of the present invention are those of a silicon wafer or a glass substrate. In one embodiment, the flat surface can be coated with at least two layers of metal. In one embodiment, the template is created by first coating the flat surface with a thin layer of metal (5-20 nm) 230, followed by another layer of metal (5-150 nm) 240. Examples of the metal suitable for the present invention include, but are not limited to, gold, silver, titanium, platinum, copper, palladium, or combinations thereof, and oxides or alloys of above-mentioned metals. In one embodiment, the metal used for formation of the first layer is titanium, and the second layer is gold. A film 280 of the valve metal with a thickness in a range of about 10 nm to about 50 μm can be subsequently deposited onto the second metal layer 240 using any physical vapor deposition techniques known to the skilled artisans (i.e., an electron beam evaporation), followed by an electropolishing in a 9:1 ethanol to water solution.

In another embodiment, the template 210 or 320 (e.g., Al, Ti, Cr, Ta, etc.) is prepared from a high purity metal sheet 310. The term “high purity metal”, as used herein, refers to a metal material with preferably at least 99% purity, and more preferably at least 99.9% purity. In one embodiment, high purity metal sheet is aluminum. In one embodiment, the high purity metal sheet is degreased, for example, with acetone followed by a cleaning in 3.0 M NaOH. In certain embodiments, the high purity metal sheet is electropolished. The term “electropolishing”, as used herein, includes an electrochemical process that removes materials from metal. In one embodiment, the high purity metal sheet is electropolished in a solution of 10% perchloric acid and 90% ethanol at 20V until a mirror finish is obtained. As used herein, the term “mirror finish” refers to a surface that is smooth or flat on a nanoscopic scale.

The metal template 210 or 320 will be made porous by anodization. The anodization of the metal film (e.g., Al, Ti, Cr, Ta, etc.) can be performed under a variety of anodization conditions. In one embodiment, a one-step anodization is carried out with the metal (e.g., Al, Ti, Cr, Ta, etc.) sheet serving as the working electrode, and a piece of aluminum foil as the counter electrode. In an alternative embodiment, a two-step anodization is performed, wherein the formed oxide layer is removed before anodization is continued to the gold layer. The anodization conditions can be chosen, for example, to be constant potential at 40 V for 25 minutes in 0.3 M oxalic acid electrolyte at 3° C. The anodization potential can be kept constant at a value of from about 5 V to about 300 V. In one embodiment of the present invention, the barrier layer at the bottom of the metal (e.g., Al, Ti, Cr, Ta, etc.) layer is removed. In one embodiment, the barrier layer at the bottom of the metal (e.g., Al, Ti, Cr, Ta, etc.) layer is removed by immersing the wafer in 5 wt % phosphoric acid solution for 25 minutes, leaving a wafer with the anodized porous template 210 sitting on top of the film (e.g., Au, Pt, Pd, Ti, Ag, etc.) 240. In one embodiment, the template 210 is the anodized aluminum oxide (AAO) template. In another embodiment, the AAO template 320 is released in saturated mercuric chloride solution. In certain embodiment, the pores of the AAO template can be further widened with etching in 5% wt phosphoric acid solution.

In some embodiments, a metal film 330 is sputter coated on one side of the template. Examples of a suitable metal of the present invention include, but are not limited to, metals such as gold, silver, titanium, platinum, copper, palladium, or combinations thereof, metal oxides, and metal alloys. In one embodiment, the metal used for formation of the metal film 330 is gold. A thickness of the metal film 330 can range from about 5 nm to about 150 nm. In some embodiments, the thickness of the metal film 330 will range from about 7 nm to about 75 nm. In one embodiment, the thickness of the metal film 330 will range from about 10 nm to about 20 nm thick.

The nanopores of the formed nanoporous template 210 or 320 can be filled with any suitable material and by any of the suitable plating techniques known to the persons skilled in the art and guided by the teachings herein provided to form nanostructures 250 or 340. Examples of material suitable for forming nanostructures include, but are not limited to, any metal resistant to corrosion or oxidation, or any alloy of such metal. In some embodiments, suitable metal or metal alloy comprise metals such as gold, platinum, palladium, osmium, and ruthenium, and alloys such as gold/silver, gold/copper, gold/zinc, and gold/aluminum. In one embodiment, the material used for the formation of the nanostructures is gold. In another embodiment, the nanostructures are made of an alloy of gold and silver.

In some embodiments, a metal or metal alloy film is first electrodeposited onto the nanoporous template 210 or 320. Electrodeposition can be conducted, as a way of an example, under a constant potential of −1.2 V in 0.25 M Na₂CO₃ solution containing 10 mM KAu(CN)₂ and 10 mM KAg(CN). It will be appreciated by the skilled artisans that the height and wall thickness of the nanostructures can be controlled by varying the electrodeposition time and anodization potential, respectfully. In some embodiment of the present invention, electrodeposition time is varied between 1 and 15 minutes, and anodization potential is varied between about 0.5 V and about 200 V. By so controlling the electrodeposition time and anodization potential, nanostructures having a height of about 0.1 μm to about 6.8 μm and an outer diameter of about 50-250 nm can be obtained.

In some embodiments, the template 210 or 320 can be removed following nanostructure formation. It is apparent to those skilled in the art and guided by the teachings herein that any suitable condition can be used for removal of the template. By way of example, the template may be removed by immersing the wafer in 1M NaOH solution for 25 minutes. In one embodiment, the template can be removed completely. In another embodiment, the template is partially removed to expose the tips of nanostructures. The term “partially”, as used herein, refers to removal of about 2 to about 98% of the template.

In some embodiments, nanostructures can be made porous by de-alloying. As used herein, the term “de-alloying” refers to a process of selective dissolution of the most electrochemically active element of an alloy, resulting in a formation of a nanoporous sponge composed almost entirely of the more noble alloy constituent. In one embodiment, de-alloying will be done by electrochemical etching in nitric acid.

In certain embodiments, the formed nanotubes 340 are filled with a sacrificial material 350. The term “sacrificial”, as used herein, refers to any suitable material that is used temporarily in order to aid in manufacturing of certain elements of the present invention. In some embodiments, a suitable sacrificial material of the present invention comprises plastics such as, but not limited to, acrylics, polyesters, silicones, halogenated plastics, and combinations thereof. In one embodiment, the porous nanotubes of the present invention will be filled with poly(methyl methacrylate) (PMMA) 350. In certain embodiments, PMMA is removed at any stage of the manufacturing process. In one embodiment, PMMA is removed prior to filling nanotubes with the electrolyte. To prevent electrical short-circuiting, connecting edges of the porous nanotubes can be sealed with polymethylsiloxane (PDMS) silicone.

In some embodiments, a preferred feature of the present invention is to make an outer surface of the nanostructures catalytically active. In certain embodiments, the outer surface is made catalytically active by coating it with a catalyst. A suitable catalytic material of the present invention comprises metals, metal oxides, and alloys such as, but not limited to, platinum, palladium, rhodium, lead, or combinations thereof. In one embodiment, the nanostructures can be coated with a thin layer of metal by electrodeposition. Any suitable conditions can be used to electrodeposit catalytic metal onto the outer walls of the nanostructure. The conditions for the electrodeposition may be chosen, as a way of an example, to be −0.45 V potential with constant flow of 0.5M Na₂SO₄ solution containing 0.1 mM potassium tetra chroloplatinate for 15 seconds. The thickness of the metal layer can be controlled by varying the electrodeposition time and by repeating the process described above.

In certain other embodiments, the outer surface is made catalytically active by functionalizing it with the catalyst. In one embodiment, the catalyst of the present invention is a macromolecule. Examples of the macromolecules include, but are not limited to, any biomolecule capable of changing a reduction/oxidation chemical transformation utilizing any known redox co-factor. One example of a macromolecule suitable for use in the present invention is glucose oxidase. The nanostructure can be functionalized with macromolecules in accordance with techniques known by those skilled in the art for depositing molecules to a surface. In one embodiment of the present invention, the surface is functionalized using a self-assembly monolayer (SAM) such as, for example, alkyl thiol. In an alternative embodiment, the surface is functionalized with macromolecules using polypyrolle polymers. Optionally, materials such as sol gel and/or carbon paste can be used to modify the surface (as a replacement for SAM or polypyrolle polymer, or in combination with either). Ways to add molecules to a surface using SAM or polypyrolle polymers are generally known in the art.

In some embodiments, nanostructures of the present invention are filled with an ion-conducting electrolyte 360. In one embodiment, the nanostructures are filled with cesium dihydrogen phosphate (CsH₂SO₄). In one embodiment, the electrolyte, e.g., CsH₂SO₄, can be dissolved in water prior to filling the nanostructures. In another embodiment, the filling process will be conducted under a vacuum suction mechanism. In this embodiment, the nanostructures are placed in a vacuum chamber. During the process of withdrawing air from the chamber, the electrolyte solution is poured into the nanostructures. It will be apparent to those skilled in the art that the high efficacy of proton transport through electrolyte will be achieved by continuous packing of the electrolyte. Therefore, it will be apparent to those skilled in the art that the viscosity of the electrolyte/water mixture can be adjusted to achieve a desired packing.

In yet another embodiment, nanostructures can be filled with electrolyte using a sol-gel method. An example of an electrolytic material suitable for packing by the sol-gel methodology is a mixture of 3-aminopropyltriethoxysilan, H₂SO₄, and water. The mixture can be prepared using various proportions of the components. In one embodiment, 3-aminopropyltriethoxysilan, H₂SO₄, and water will be mixed at a molar ratio of 1:1:100. In another embodiment, the solution (sol) of 3-aminopropyltriethoxysilan, H₂SO₄, and water is stirred continuously for 1 day at 0° C. Filling of the nanostructures with the sol can be conducted, as a way of an example, under vacuum at 25° C. Once the hybrid sol gels, it can be dried at 50° C. for 1 day. To further solidify the sol-gel, the sol-gel filled stereo structures can be heat treated at 100, 150 and 200° C. for 3 hours at each temperature.

In another embodiment, at least one of the nanostructure-enhanced stereo-electrodes is converted into a reference electrode. In one embodiment, at least one of the nanostructure-enhanced stereo-electrodes is converted into a Ag/AgCl reference electrode. In certain embodiments, the nanostructures can be coated with a thin layer of Ag/AgCl by electrodeposition. The electrodeposition may be performed, as a way of an example, under an electrical biasing current of 10 mA/cm² in a potassium silver cyanide solution for 30 seconds. To convert the deposited silver to silver chloride, the specimen can be dipped in a 50 mM FeCl₃ solution for about 50 seconds. It is understood that this process will only modify the electrically biased electrodes (i.e., electrodes that are connected to the electrical source and held at a negative potential) and not the adjacent electrodes.

### IV. Electrochemical Conversion Devices Containing Nanostructure-Enhanced Stereo Electrodes

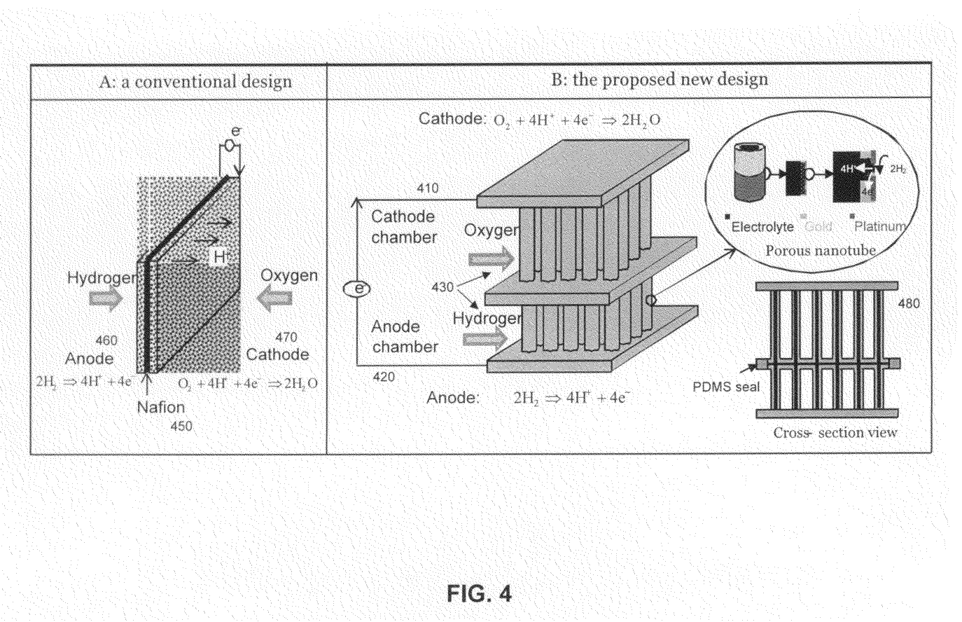

Another aspect of the present invention describes an electrochemical conversion device containing nanostructure-enhanced stereo electrodes. One embodiment of the present invention describes a fuel cell. In the embodiment illustrated in FIG. 4B, the fuel cell comprises a cathode chamber 410 and an anode chamber 420, each comprising porous nanotube-enhanced stereo electrodes 430 (FIG. 4B). Unlike the traditional layer-design of a fuel cell, such as the one illustrated in FIG. 4A, wherein a catalytic membrane 450 sandwiched between an anode 460 and cathode 470 electrodes (FIG. 4A), porous nanotube-enhanced stereo electrodes of the present invention are used for the catalytic surface.

In one embodiment, the porous nanotubes of the nanostructure-enhanced stereo-electrodes within the fuel cell have an outer diameter in a range of about 40 to about 250 rm. In certain embodiments, the porous nanotubes have an outer diameter in a range of about 120 to about 170 nm. In yet another embodiment, the outer diameter of the porous nanotubes range between about 130 nm and about 160 nm. In one embodiment, the porous nanotubes of the nanostructure-enhanced stereo-electrodes within the fuel cell of the present invention have an outer diameter of about 150 nm. In one embodiment, the porous nanotubes have an inner diameter in a range of about 20 to about 230 nm. In another embodiment, the porous nanotubes have an inner diameter in a range of about 100 to about 150 nm. In yet another embodiment, the inner diameter of the porous nanotubes of the present invention ranges between about 110 nm and about 140 nm. In one embodiment, the porous nanotubes of the present invention have an inner diameter of about 120 nm. In some embodiments of the present invention, the height of porous nanotubes ranges between about 10 nm and about 50 μm. In one embodiment, the porous nanotubes have a uniform height in the range of about 0.1 μm to about 6.8 μm. In certain embodiments, a spacing between the porous nanotubes will range from about 120 to about 700 nm. In one embodiment, the spacing between the porous nanotubes will range from about 100 to about 600 nm. In yet another embodiment, the spacing will range from about 95 to about 500 nm.

In one embodiment of the present invention, the porous nanotubes of the stereo-electrodes are filled with an ion-conducting electrolyte. To assure an efficient conduction of electric charges, the porous nanotubes are completely filled with the electrolyte. The electrolyte of the present invention can be solid or liquid. In certain embodiment, the electrolyte comprises solid electrolytes such as, but not limited to, CsH₂SO₄, NaCl, Ag₂S, AgI, PbCl₂, RbAg₄I₅, or combinations thereof. In one embodiment, the porous nanotubes are filled with CsH₂SO₄. In certain embodiments of the present invention, the catalytic surface of the fuel cell comprises a 3D interconnected electrolytic network 480 formed by stacking electrolyte-filled nanotube-enhanced stereo-electrodes on top of each other, electrolyte layer to electrolyte layer (FIG. 4B). The stacked electrodes are stacked pair-wise (e.g., 2, 4, 6, 8, etc.).

In another embodiment, a preferred feature of the invention is to make the outer surface of at least one of the porous nanotubes catalytically active. In certain embodiments, the outer surface is made catalytically active by coating it with a catalyst. In one embodiment, the porous nanotubes can be coated with a thin layer of platinum.

Examples of fuel cells suitable for the present invention include, but are not limited to, proton exchange fuel cell, oxygen ion exchange fuel cell, microbial fuel cell, molten-carbonate fuel cell, and phosphoric acid fuel cell. One embodiment of the present invention provides a proton exchange fuel cell. In certain embodiments, a suitable fuel utilized by the proton exchange fuel cell of the present invention comprises substances such as, but not limited to, hydrogen gas, water, hydrocarbons, alcohols, or combinations thereof. In one embodiment, the fuel utilized by the fuel cell of the present invention is hydrogen gas. Hydrogen gas, being an energy carrier, must be produced from an energy source. Examples of energy sources suitable for the production of hydrogen include, but are not limited to, carbohydrates, petroleum, coal, natural gas, wind power, and solar photovoltaic cells. In one embodiment, hydrogen gas can be generated through electrolysis of a chemical substance such as water or hydrocarbons. In another embodiment, hydrogen gas can be generated by enzymatic break down of glucose by microorganisms.

One of the major shortcomings of a conventional fuel cell design is a voltage loss resulting from a markedly decreased rate of O₂ reduction at the cathode compared to the oxidation rate of H₂ at the anode. [Zhang et al, 2004, 2005; Anderson 2002]. The large drop in reduction rate is caused by the high mass-transport resistance at the cathode. [Guvelioglu and Stenger, 2005; Zhukovsky, 2003; Anderson, 2002]. The design of the fuel cell described herein will allow to adjust the heights of the anode and cathode chambers in order to provide more efficient means for catalytic conversion and mass transport at the desired chamber. Additionally, different geometric settings for the diameter and spacing of the nanotubes can be used to further customize the performance of the device. By way of example, the dimensions of the chambers (e.g., the diameters, spacing, and height of the nanostructures) can be individually adjusted to accommodate the difference in reaction rates and mass transport in the two half cell reactions in the cathode and anode chambers.

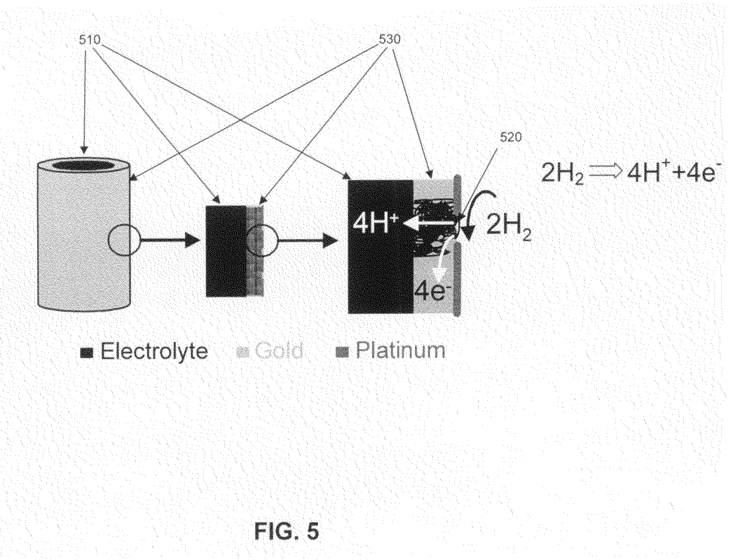

In the embodiment depicted in FIG. 5, the electrolyte 510 exposed at the pores 520 of the porous nanotube 530 forms a catalyst-electrolyte-electrode junction in a three-phase-contact manner. This design allows for effective Pt-catalyzed oxidation of hydrogen gas, resulting in a production of protons and electrons. The 3D-interconnected electrolytic network 480 formed by stacked porous nanotubes mediates immediate transport of the generated protons to the cathode chamber 410, while the electrons are collected by the porous nanotube-enhanced stereo electrodes 430 or 530.

Unlike the traditional 2D layer-structure design, the 3D stereo-structure proposed herein provides unprecedented surface area for ionization, deionization, and the transport of ions and electrons in a most efficient and effective three-phase-contact manner. By entrapping a solid acid electrolyte inside the porous nanostructures (impermeable to water thus making the electrolyte less prone to attacks by water), reduced voltage loss occurs and allows high temperature operations of the device. This eliminates CO-poisoning of the Pt catalyst, leading to greater effectiveness of the Pt catalyst and relaxing the purification requirements for the hydrogen fuel. With only a monolayer of Pt coated on the outer walls of the porous nanotubes, the amount of Pt loading as catalyst can be kept at minimum while its effectiveness at maximum, thus reducing the cost for such fuel cells.

In certain embodiments, the fuel cell of the present invention comprises electrolyte-filled nanotube-enhanced stereo-electrodes stacked on top of each other, electrolyte layer to electrolyte layer (i.e., the 3D interconnected electrolytic network 480) placed inside a microfluidic housing. The term “microfluidic housing”, as used herein, refers to any housing that geometrically constrains fluids to a small, sub-milliliter scale. In some embodiment, the microfluidic housing will contain inlets and outlets for gases and liquids. In one embodiment, the microfluidic housing contains inlets for the hydrogen and oxygen gases, and an outlet for water. Additionally, the fuel cell of the present invention comprises a cathode chamber 410 and an anode chamber 420. In some embodiments, the cathode chamber 410 and the anode chamber 420 of the fuel cell are made of the 3D interconnected electrolytic network 480 placed inside the fuel cell. In one embodiment, the cathode chamber 410 will have the same geometric setting (i.e., height) as the anode chamber 410. In other embodiments, the cathode chamber is about 10% to about 90% taller than the anode chamber.

### V. Biosensors Containing Nanostructure-Enhanced Stereo-Electrodes

Another aspect of the present invention provides biosensors equipped with nanostructure-enhanced stereo-electrodes. Biosensors have potential use as a method of detection in many areas, including environmental, fermentation, food and medical areas. Biosensors could be used for in vivo or in vitro sensing in humans or animals. Currently, biosensors have a tendency to have low sensitivity, poor specificity and are prone to fouling. The biosensors of the present invention alleviate these problems.

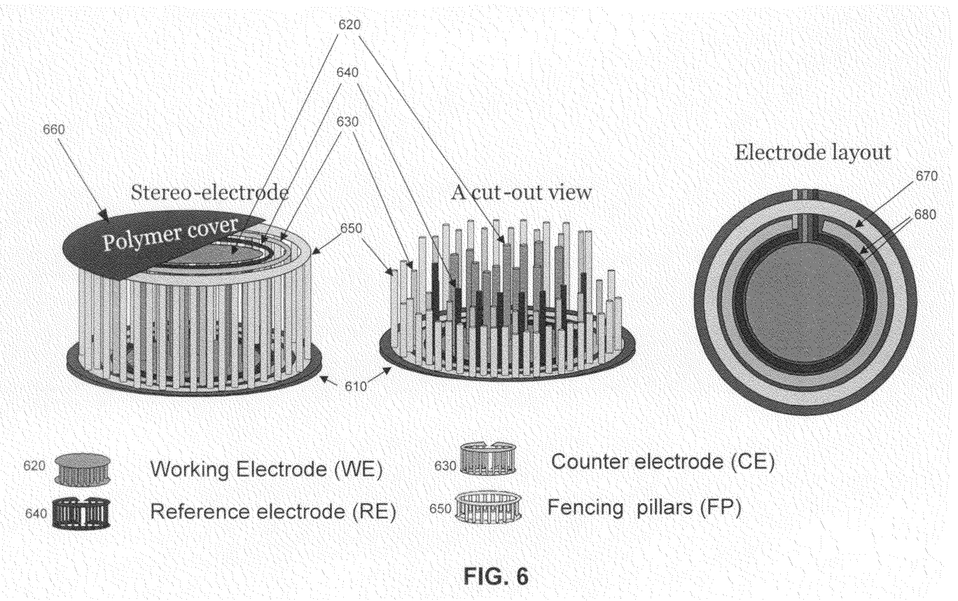

In some embodiments of the present invention, the biosensor is comprised of stereo-electrodes made of an array of nanostructures attached at each end to a support base. In the embodiment illustrated in FIG. 6, the biosensor comprises a flat discus surface 610 and three-electrode set comprised of arrays of porous nanostructures comprising the working electrode (WE) 620, counter electrode (CE) 630 and reference electrode (RE) 640. In certain embodiments, the flat discus surface 610 will have a thickness of about 5 μm to about 40 μm. In other embodiments, the flat discus surface 610 will have a thickness of about 15 μm to about 30 μm. In one embodiment, the thickness of the surface 610 is about 20 μm. The diameter of the flat discus surface 610 will range from about 0.5 mm to about 20 mm. In some embodiments, the diameter of the flat discus surface 610 will range from about 1 mm to about 10 mm. In one embodiment, the surface 610 has a diameter of about 5 mm.

In the embodiment illustrated in FIG. 6, the biosensor additionally comprises concentric O-shape 670 and C-shape 680 plates supporting the nanopillars. It will be apparent to the skilled artisan that the spacing between the supporting plates can be easily varied. In certain embodiments, the spacing between the supporting plates can be uniform or non-uniform, and can be between about 50 μm and about 150 μm. In some embodiment, the spacing between the supporting plates will be between about 70 μm and about 120 μm. In one embodiment, the supporting plates will be about 100 μm apart.

In one embodiment, the biosensor of the present invention comprises a ring structure comprising array of nanopillars 650 serving as the “fencing pillars” situated on the edge of the disc 610 (FIG. 6). In some embodiments, a preferred feature of the present invention is to coat the outer walls of the fencing nanopillars with inert molecules to render them non-adsorbable to microorganisms. In one embodiment, the outer walls of the fencing nanopillars are coated with inert molecules through either self assembly monolayer (SAM) molecules or polypyrrole polymer. Examples of inert molecules suitable for the present invention include, but are not limited to, polyethylene glycol, polysterene, and polypropylene glycol. In another embodiment, a material capable of catalyzing a redox reaction can be affixed onto the outer walls of the working electrode. In one embodiment, the catalytic material affixed onto the outer surface of the working electrode is an alloy of platinum and lead. In another embodiment, the catalytic material is glucose oxidase.

The diameter and spacing between the nanostructures can be controlled to achieve the optimal catalytic conversion, electron transfer, mass transport, and biofouling prevention. The fencing nanostructures provide a physical filtration structure that helps prevent microorganisms and proteins from reaching the detection electrodes in the center and thus prevents biofouling of the active electrodes. In certain embodiments, an inter-pillar spacing will range from about 120 to about 700 nm. In one embodiment, the inter-pillar spacing will range from about 100 to about 600 nm. In yet another embodiment, the inter-pillar spacing will range from about 95 to about 500 nm. Moreover, the large surface area provided by the cylindrical walls of the nanostructures can provide an unprecedented large surface area for enzymatic conversion and electron transfer. Unlike the traditional 2D substrate-type design, the stereo design of the electrodes provided herein allows large surface areas for catalytic conversion and electron transfer.

### VI. Integrated Micro/Nanoscale Structures and Method for Producing Thereof

Microfabrication procedure has a strong impact in most of the areas of contemporary science and technology and the knowledge and experimental procedures for miniaturization were transferred from electronics also to chemistry and biochemistry for creating sensors with better performances. The ability to generate patterns of biomolecules on different material surfaces is important for biosensor technology, tissue engineering, and fundamental studies in cell biology. There are several well established ways to pattern biomolecules onto substrates, such as photolithography, soft lithography, nano-pen lithography, and spotting techniques.

Photolithography, or patterning materials using photoresists and etching, is a technology known in the art, which has been advanced by progress in microelectronics where structures on the order of microns and submicrons are used. One of the major disadvantages of this technique, as it is known to date, is its inability to form structures with micro and nano (<100 nm) features on common wafers such as glass or silicon without causing severe deformation in the nanostructures due to its wet-process nature. Since the techniques of photolithography and microfabrication are widely accessible and commonly used at research labs and manufacturing facilities, any new process that is compatible with these techniques will bring widespread applications. Moreover, such a compatibility is also vital for a large-scale production of the said structures and electrodes, thus lowering the cost of production

One aspect of the present invention provides a process for producing integrated structures of micro- and nano-scale features on glass or silicon substrates. In some embodiments, such structures can be produced by micropatterning. In one embodiment, micropatterning can be achieved by coating the wafer enhanced with nanopillars fabricated by the process described above with a positive or negative photoresist (i.e., Photoresist 1818 or SU-8). The term “photoresist”, as used herein, refers to light-sensitive materials used to form a patterned coating on a surface (i.e., polyhydroxystyrene-based polymers). In one embodiment, photoresist may be applied to the wafer prior to the template removal. In another embodiment, the template will be removed prior to photoresist deposition. Photoresist may be deposited on the wafer using any of the variety of deposition techniques known to people skilled in the art. Examples of the suitable deposition techniques include, but are not limited to, spin-coating and electrodeposition. In some embodiments, photoresist will be spin-coated onto the wafer, followed by an exposure to a UV light through a micropattern mask 260. In some embodiments, the micropattern will be developed using a suitable developer solution (i.e., Microposit M 319). Following the development of the micropattern, the unmasked titanium and gold layers can be removed. In some embodiments, the unmasked titanium and gold layers will be chemically etched, and photoresist stripped. Chemical etching can be done using any suitable material capable of dissolving metal (i.e., acid or base). In one embodiment, photoresist will be stripped from the wafer using any suitable photoresist strippers (i.e., hydroxylamine). Following micropatterning, the template can be removed by, for example, immersing the wafer in 1M NaOH solution for 25 minutes.

### VII. Microflow Channel Biosensor

Another aspect of the present invention provides a microflow channel biosensor with planar electrodes incorporated with nanostructures. It has been theorized that electrical current response of nanostructured electrodes depends on, among other factors, transport of analyte molecules to the active surface of the nanostructures, a process known as mass transport. Higher current response is achieved in instances wherein an analyte is able to diffuse into the deep spaces between the nanostructures to get oxidized. The detection sensitivity of the nanostructured devices known in the art has been limited by the diffusion rates of the analytes. A nanostructure-enhanced microflow channel biosensor described herein allows for bypassing a diffusion-limited sensor response by providing a convective transport of analyte molecules within said biosensor.

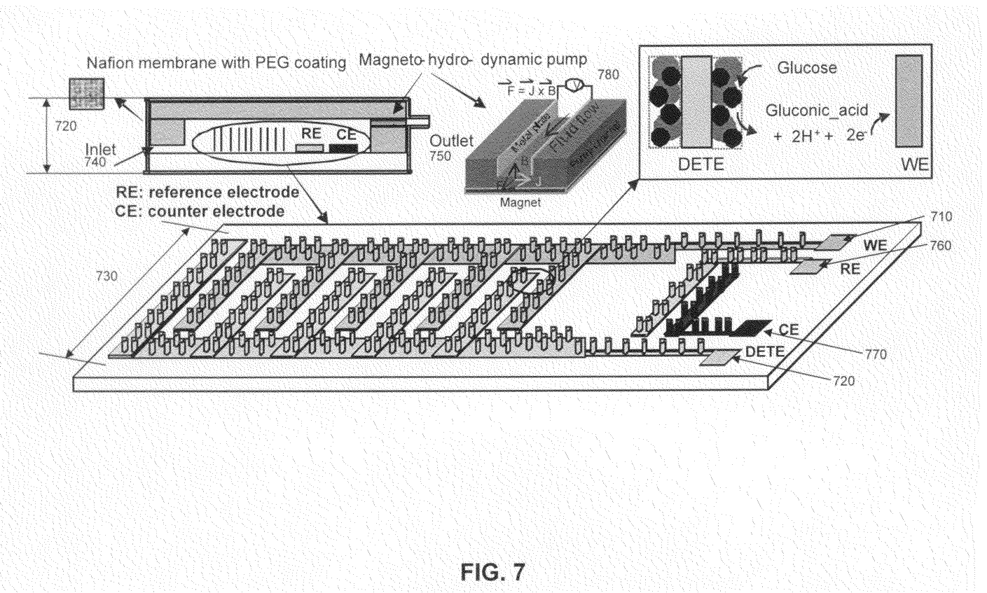

The present invention provides new arrangements of electrodes in a microflow channel biosensor, wherein planar electrodes are microscale-interdigitated, FIG. 7. In one embodiment, a working electrode 710 is placed next to a detector electrode 720 in an alternating manner. Such design results in the enhanced performance of said biosensors, as judged by the improved collection and detection efficiency, due to the proximity of working and detecting electrodes.

In some embodiment, the working electrode can comprise a material capable of catalyzing a redox reaction. In some embodiments, the catalytic material of the present invention is an alloy of platinum and lead. In other embodiments, the catalytic material of the present invention can be a macromolecule. One example of a macromolecule suitable for use in the present invention is glucose oxidase.

In some embodiments of the present invention, a microflow channel 720 consists of a micro-interdigitated array 730 of working electrodes 710 and detector electrodes 720. Although microflow channel shown in FIG. 7 is equipped with an inlet 740, an outlet 750, and a pump 780, and additionally contains a reference electrode 760 and a counter electrode 770, it is apparent to those skilled in the art and guided by the teachings herein provided that in alternative embodiments, microflow channel of the present invention may be equipped with a number of other features suitable for its operation

### VIII. Methods of Use

Another aspect of the present invention provides methods of using the stereo-electrode containing devices described herein. The vast number of potential applications of the devices described herein will be immediately apparent to persons skilled in the art. Below are but a few embodiments describing potential utilities of such devices.

In some embodiments, the fuel cells containing the nanostructure-enhanced stereo-electrodes described herein can be used as power sources in remote locations, such as spacecraft, remote weather stations, large parks, rural locations, and in certain military applications. Certain applications of the fuel cells described herein include, but are not limited to, base load power plants, electric and hybrid vehicles, auxiliary power, notebook computers, portable charging docks for small electronics, smartfones with high power consumption due to large displays, and additional features like GPS.

Another embodiment provides a method for use of the biosensors integrated with the nanostructure-enhanced electrodes fabricated by the process of the present invention for monitoring a target analyte level, comprising:
1) bringing said biosensor in contact with a sample;
2) detecting generation of free electrons;
3) determining whether the sample contains the target analyte by measuring an amperometric current, wherein the presence and magnitude of the current indicates the presence and the amount of the target analyte in the sample.

In some embodiments, biosensors integrated with nanostructures described herein can be used for a detection of a target analyte level in biological fluids. Examples of the target analytes include, but are not limited to, endogenously found molecules (i.e., glucose or lactose), exogenously consumed species (i.e., drugs or alcohol), toxic metabolites (mycotoxins), and pathogens (i.e., E. coli or Salmonella). Examples of the biological fluids include, but are not limited to blood, urine, serum, saliva, cerebra-spinal fluid, and semen. In other embodiments, biosensors integrated with nanostructures described herein are useful for environmental applications, such as detection of pesticides and river water contaminations. In some embodiments, biosensors integrated with nanostructures described herein can be used for a remote detection of biological warfare agents. Examples of the biological warfare agents include but not limited to: anthrax, ebola virus, ebola, Marburg virus, plague, cholera, tularemia, brucellosis, Q fever, machupo, Coccidioides mycosis, Glanders, Melioidosis, Shigella, Rocky Mountain spotted fever, typhus, Psittacosis, yellow fever, Japanese B encephalitis, Rift Valley fever, and smallpox. Naturally-occurring toxins that can be used as weapons include ricin (WA), SEB (UC), botulism toxin (XR), saxitoxin (TZ), and many mycotoxins.

In some embodiments, biosensors integrated with nanostructures described herein can be used for determining levels of toxic substances before and after bioremediation. In other embodiments, the biosensors integrated with nanostructures described herein find their application in drug discovery and evaluation of biological activity of new compounds. In yet another embodiment, the biosensors described herein are useful in determination of drug residues in food, such as antibiotics and growth promoters.

### EXAMPLES

### Example 1

Fabrication Process Used To Integrate Micro And Nanoscale Features Onto A Solid Substrate

| | |
|---|---|
| Step 1: | Sample preparation: A silicon wafer 220 is coated with a thin layer of titanium |
| | 230 (10 nm) followed by a layer of gold 240 (100 nm). Subsequently, a thick layer |
| | of aluminum (μm) is coated using an e-beam evaporator. |
| Step 2: | Electropolishing: The Al layer 280 is then electropolished in a 9:1 ethanol to |
| | water solution. |
| Steps 3-5: | Anodization: A two-step anodization process is performed at a constant potential |
| | in oxalic acid. The Al layer is first anodized for a short duration followed by oxide |
| | layer removal using chromic acid solution. Then, second anodization is carried |
| | out all the way to the gold layer, leaving a wafer with the anodized aluminum |
| | oxide porous template 210. |
| Step 6: | Electrodeposition: Gold nanopillars 250 are formed by electrodeposition into the |
| | nanopores in a gold cyanide bath. |
| Steps 7-10: | Micro patterning: Photoresist 1818 (positive photoresist) 270 is spin coated on |
| | the sample and then exposed to UV light through a micro pattern mask 260. Then, |
| | the micro pattern is developed using MF 319 developer solution. Then, the |
| | unmasked gold and titanium layers are etched chemically following which the |
| | photoresist is chemically stripped. |
| Step 11: | Anodized alumina removal: The patterned sample is then placed in 2.0M NaOH |
| | solution to dissolve away the anodized alumina, leading to a micro patterned |
| | structure with nanopillars. |

### Example 2

### Fabrication of Nanostructure-Enhanced Stereo Electrodes

Fabrication of templates: To fabricate nanoporous templates, the two-step anodization technique is used. High purity (99.9%) aluminum sheets (Alfa Aesar, MA) of a desired size (typically 1-5 cm²) are degreased in acetone and dipped in 3.0 M NaOH solution for cleaning. The sheet specimens are electropolished in a solution of 10% perchloric acid+90% ethanol at 20V until a mirror finish is obtained. For the first anodization, an electrical potential (ranging from 70V to 180V for pores of 90 nm to 240 nm in diameters) is applied to the specimens in 0.3 M oxalic acid electrolyte for 1 hour with the temperature of the electrolyte maintained around 3° C. Following that, the formed oxide layer is stripped by dipping the specimen in a solution of 6% wt phosphoric acid+1.8% wt chromic acid at 60° C. for 30 minutes. Then a second anodization is applied using the same setting as the first anodization until a desired pore height is reached (typically 1-500 μm). After rinsing in DI water, the specimens are placed in saturated mercuric chloride solution for approximately 30 minutes to release the anodized alumina oxide (AAO) porous templates. The pores of the AAO template can be further widened with etching in 5% wt phosphoric acid solution. AAO templates with pore sizes from 100 nm to 250 nm can be used.

Development of arrays of porous nanostructures using an Au/Ag alloy: Nanostructures can be fabricated through electrodeposition along the inner walls of these pores. Starting with the AAO templates developed above, a thin gold film about 50 nm thick is sputter coated on both sides of the templates (to hold the nanostructures in place and prevent them from collapsing; all tubes remain open). To make the tubes porous, alloy tubes can be first deposited using a binary system of Au and Ag and then the Ag part etched away. Electrodeposition is accomplished under a constant potential of −1.2V (applied to the sputtered Au film to form tubes with a wall thickness of 10-20 nm; Anandan and Zhang, 2007; Lee et al., 2005) in 0.25 M Na₂CO₃ solution containing 10 mM KAu(CN)₂ and 10 mM KAg(CN) using a three-electrode system with Pt counter electrode and Ag/AgCl reference electrode. With this procedure, the pores on the tubular walls (anticipated to be around 5-10 nm) can be tuned by adjusting the concentration ratio of KAu(CN)₂ and KAg(CN)₂ [Ji et al., 2002]. This feature is important to fine-tuning the pore size for achieving the highest efficiency in catalytic conversion. Silver in the Au/Ag alloy is then etched away in nitric acid to form porous nanopillars. After that, the AAO template is removed by immersing the specimens in 2M NaOH.

Deposition of monolayer Pt catalyst: Before depositing monolayer Pt catalyst, the hollow cores of the nanopillars are filled with sacrificial PMMA. The specimens are then cleaned with cyclic voltammetry in 0.5 M H₂SO₄ at 10 mV/sec from −0.3V to 1.3V and rinsed with 0.5 M Na₂SO₄ solution (pH 4.3). For depositing monolayer Pt catalyst, a under potential electrodeposition of a monolayer layer of lead (Pb) is first applied to the gold nanopillars by applying of −0.45V with constant flow of 0.5M Na2SO4 solution containing 1 mM of Pb(ClO₄)₂ for 15 second. After that, a rinsing step was applied with constant flow of 0.5 M Na₂SO₄ solution. At this stage, a monolayer of platinum was deposited by a lead-replacing reaction through constant flow of 0.5M Na₂SO₄ solution containing 0.1 mM Potassium tetra chloroplatinate for 15 seconds. For a thicker Pt layer, the above steps were repeated with each repeat placing an additional monolayer of Pt onto the surface. The sacrificial PMMA filler is finally removed using a stripping agent “Remover PG” (Micro Chem. Corp., Newton, Mass.) at 50° C. with slight agitation for 10 minutes.

Filling of electrolytes and assembly of a fuel-cell unit: At this stage, solid acid electrolyte such as CsH₂PO₄ dissolved in DI water can be used to fill the porous nanotubes through the open ends of the nanotubes. To fully fill the nanotubes, this step is expected to be repeated with proper heating in a vacuum environment until an electrolyte cover formed. After that, two such structures are stacked together (electrolyte side to electrolyte side) with the connecting edges sealed with PDMS silicone for preventing electrical shorting. To form a fuel-cell unit, the developed structure can be placed in a micro-fluidic housing with respective inlets and outlets for hydrogen gas and oxygen air and water. In stacking up, the nanotubes in the anode and cathode chambers need not be aligned one-to-one, because the entrapped electrolyte can serve as a conduit network for transporting protons from the anode to the cathode.

### Example 3

### Fabrication of Biosensors

As schematically shown in FIG. 6, this glucose sensor can be developed with stereo electrodes made of array of nanopillars attached to a base and top plates. A typical configuration of such a new sensor would be a circular disc with a thickness of about 20 μm and a diameter of about 5 mm. Besides these overall dimensions, FIG. 6 also shows a set of dimensions for the concentric O-shape and C-shape supporting plates that hold together the nanopillars. These concentric structures can be placed with a 100 μm wide gap in between them. These dimensions can be adjusted or scaled up or down for specific application needs. The diameters of the fencing and electrode nanopillars are expected to be varying from 50 to 250 nm (with an inter-pillar spacing from 100 to 500 nm) to meet the needs for fouling prevention, catalytic conversion and mass transport. The developed sensors can be tested in a standalone mode and in a flow-channel mode.

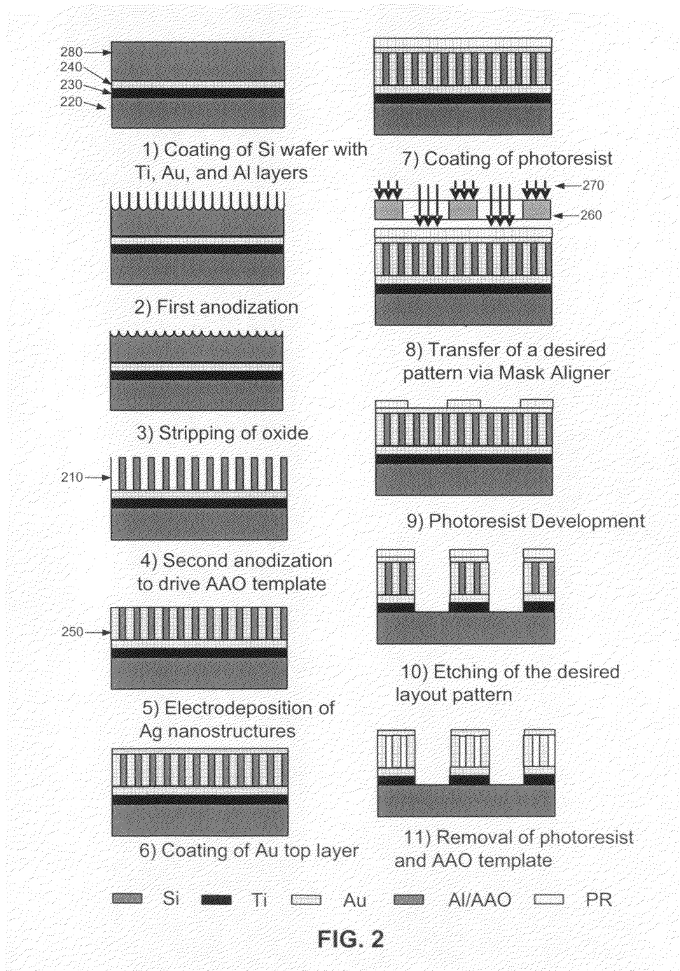

Fabrication of three-electrode sets of array structures of nanopillars. FIG. 2 shows a flow chart for the fabrication process for the three-electrode set of forest structures. A silicon wafer is first cleaned using a standard RCA cleaning procedure and coated consecutively with a thin layer of titanium (Ti; 10 nm), a layer of gold (Au; 20 nm) and a thick layer of aluminum (Al; an anticipated thickness is from 5 to 50 μm) using an E-beam evaporator (step 1). Then a two-step anodization process is applied. For the first anodization (step 2), an electrical potential (ranging from 40 to 180V for pores of 50 to 250 nm in diameters) is applied to the specimens in 0.3 M oxalic acid electrolyte for 5 minutes with the temperature of the electrolyte maintained around 3° C. Following that, the formed oxide layer is stripped by dipping the specimen in a solution of 6% wt phosphoric acid+1.8% wt chromic acid at 60° C. for 30 minutes (step 3). Then a second anodization is applied using the same setting as the first anodization until the pores reach the Au layer through the monitoring of the anodization current. This leaves an anodized alumina oxide (AAO) porous template sitting on top of the Au layer (step 4). Although AAO templates with pore sizes from 50 nm to 250 nm can be developed, the actual dimensions for these pores will be in accordance with the simulation results. After that, gold nanopillars are electrodeposited through the open pores of the AAO template under an electrical current of 5 mA/cm² at 65° C. in a gold potassium cyanide bath (step 5). Then a top layer of gold film (100 nm) is added (step 6). At this stage, a microfabrication process is applied to develop the desired pattern for the electrode set using a mask with the layout pattern of the three-electrode set. Photoresist 1818 (positive photoresist) is spin-coated on the specimen (step 7), and the layout pattern is transferred through UV exposure using a mask aligner (step 8). The exposed photoresist is stripped away using MF 319 developer solution (step 9). Following that, the unmasked Au layer is chemically etched at 25° C. in a solution of KI:I₂:H₂O in a 4:1:40 ratio and the Ti layer is etched in a solution of H₂O:HF:H₂O₂ in a 20:1:1 ratio (step 10). Finally, the photoresist is chemically stripped and the AAO template is dissolved in 2.0M NaOH solution leading to a three-electrode set of forests of nanopillars (step 11).

Conversion of the three-electrode sets into functional electrochemical electrodes. For functional electrodes, both the reference and working electrodes need to be modified. For the reference electrode, to assure the RE nanopillars to have a constant potential drop across the electrode/electrolyte interface, the surface of these RE nanopillars can be modified into Ag/AgCl. To do that, silver can first be electrodeposited onto the RE nanopillars under a current of 10 mA/cm² in a potassium silver cyanide bath for 30 seconds. To convert the electrodeposited silver to silver chloride, the specimen can be dipped in a 50 mM FeCl₃ solution for about 50 seconds. In our preliminary study it was found that this process does not affect the adjacent Au nanopillars. After rising thoroughly in DI water, the working electrode can be functionalized with glucose specific GOx enzyme. To do that, an electro-deposition/polymerization procedure in a 0.1 M KCl solution containing a mixture of 0.05 M pyrrole and 0.5 mg/ml of GOx can be applied to the WE nanopillars by passing a galvanostatic current at 50 μA/cm² for about 50 minutes at 25° C.

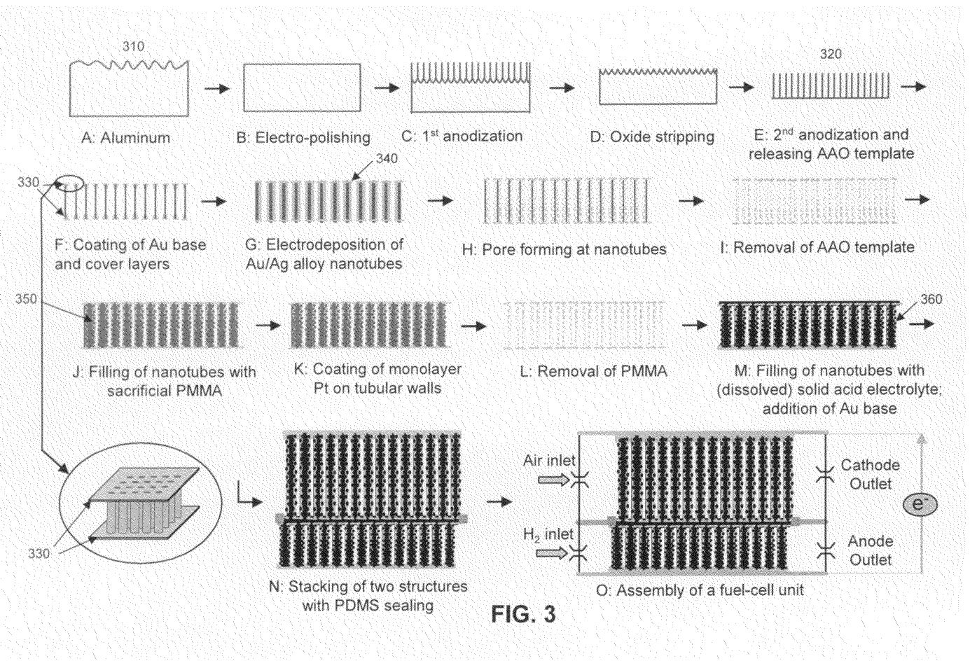

Development of ring structures of fencing nanopillars. To fabricate a ring structure of fencing nanopillars, a slightly different approach can be used. As shown in FIG. 3, a high purity (99.9%) aluminum sheet of a desired size (typically 1 cm²) is degreased in acetone and dipped in 3.0 M NaOH solution for cleaning (step 1). The sheet specimen is electropolished in a solution of 10% perchloric acid+90% ethanol at 20V until a mirror finish is obtained (step 2). Then the two-step anodization process is applied (steps 3 through 5). After rinsing in DI water, the specimen is placed in saturated mercuric chloride solution for approximately 30 minutes to release the anodized alumina oxide (AAO) porous templates (step 6). The pores of the AAO template can be further widened with etching in 5% wt phosphoric acid solution. Again, AAO templates with pore sizes from 50 to 250 nm are expected to be fabricated, but the actual dimensions for these pores will be in accordance with the simulation results. At this stage, an Au base is coated on one side of the AAO template (step 7), then gold nanopillars can be electrodeposited through the pores from the open side to fill the pores (step 8), and finally an Au top layer is added (step 9). Following that, the same masking and patterning procedures as in FIG. 2 with a mask of a ring pattern is applied to construct a ring structure of fencing nanopillars.

Modification of the fencing nanopillars with PEG. To make the fencing nanopillars non-adsorbable to microorganisms and proteins, the surface of the nanopillars can be modified with poly(ethylene glycol) (PEG), a hydrogel widely used in biomaterials and pharmaceutical applications. PEG molecules are polar, uncharged and flexible [Winsniewski et al., 2000; Unsworth et al., 2005a, 2005b; Bretagnol et al, 2006]. Coating of PEG above a solid surface can mask the underlying surface by producing a hydrophilic interface between the solid surface and aqueous bulk which inhibits the adsorption of proteins and microorganisms. For this project, the commonly used approach of chemisorption of PEG thiols on gold can be used [Unsworth et al., 2005a, 2005b]. To do that, the fencing nanopillar structures are first cleaned in a solution of H₂O₂:NH₄OH:H₂O in a 1:1:5 ratio at 80° C. for 5 minutes with sonication. After rinse, the specimens are equilibrated in milli-Q water, and then immersed in a chemisorption solution of 5 mM end-thiolated methoxy-terminated polyethylene oxide for 2 hours at room temperature.

Assembly of glucose sensor devices. For electrodes to be evaluated in bare conditions, no assembly is necessary. But for electrodes to be tested as functional ones, glucose sensor devices can be fabricated by assembling the ring structure of the fencing nanopillars onto the substrate holding the three-electrode set of electrode nanopillars. For prototype evaluations in this project, polymeric adhesives, like silicone (PDMS) gels, can be used to fasten the ring structure onto the substrate to enclose the three-electrode forest structures. A polymer cover 660 can be added on top of the disc sensor devices (FIG. 6).

### Example 4

### Evaluation of the Sensitivity of the Nanopillar Array Structures

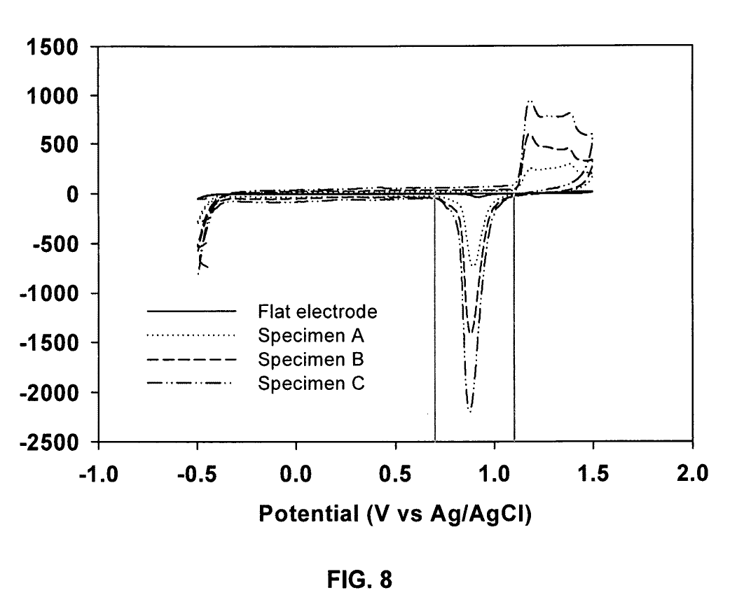

FIG. 8 shows some cyclic voltammograms (CV) for three nanopillar electrodes with gold nanopillars of different heights: 1 μm (specimen A), 2.5 μm (specimen B) and 6 μm (specimen C) measured in 0.3 M sulphuric acid [Anandan et al., 2006; 2007]. In each CV curve, an Au-oxide reduction peak is seen in between 0.7 and 1.1 V as expected because of the Au-oxide reduction occurring at the electrode/electrolyte interface. To quantify the increase in the surface area of these nanopillar electrodes we calculated a roughness ratio as the area under the reduction peak (by integrating the voltammogram from 0.7 V to 1.1 V) of a nanopillar electrode to that of the flat electrode. The roughness ratio is found to be about 20.1, 38.8 and 63.4 for specimens A through C, respectively. This indicates that the surface area of specimen C (with 6 μm tall nanopillars) is about 63 times larger than that of the flat electrode.

This increase is attributed to the additional surface area provided by the cylindrical walls of the nanopillars. As schematically shown in FIG. 1, by isolating a unit-cell from a nanopillar array structure, we calculated the ratio of the surface area of the cylindrical wall to the projected area as ΔS/S₀=2πrh/L², where r is the radius of the nanopillar, h is the pillar height, and L is the width of the unit-cell. When r=100 nm and h=2 μm along with a pillar packing density (p=πr²/L²) of 25%, ΔS/S₀ is found to be 10. This means that the surface area provided by the side walls of the nanopillars can be significantly larger than the area of the flat base and it can get even larger as the height and the packing density of the nanopillars increase. Based on the above formula along with the estimated r=150 nm, h=6 μm and p=75% for the nanopillars, we calculated an increase of 60 times in surface area, which is almost the same as the measured value (i.e., 63.4). This surface area increase, however, did not lead to the same level of sensitivity increase (which is only about 12 times). This is attributed to the diffusion limit encountered in a diffusion driven mass-transport process [Yang and Zhang, 2005; 2006; 2007a; 2007b]. The new glucose sensor can take full advantage of this additional surface under a convective flow such that the diffusion limit is not a concern.

### REFERENCES

1. Anandan V, Yang X, Kim E, Rao Y L and Zhang G. Role of Reaction Kinetics and Mass Transport in Glucose Sensing, Journal of Biological Engineering, doi:10.1186/1754-1611-1-5, 2007.
2. Anandan V, Rao Y, Zhang G. Nanopillar Array Structures for Enhancing Biosensing Performance. International Journal of Nanomedicine. Vol. 1, No. 1, 73-79, 2006.
3. Anderson A B. O2 reduction and CO oxidation at the Pt-electrolyte interface. The role of H2O and OH adsorption bond strengths. Electrochimica acta. 47, 3759-3763, 2002.
4. Guvelioglu G H and Stenger H G. Computational fluid dynamics modeling of polymer electrolyte membrane fuel cells. J Power Sorves, 147, 95-106, 2005.
5. Ji C, Searson P C. Applied physics letters. 81 (23), 4437-4439, 2002.
6. Unsworth L D, Sheardown H and Brash J L, Polyethylene oxide surfaces of variable chain density by chemisorption of PEO-thiol on gold: Adsorption of proteins from plasma studied by radiolabelling and immunoblotting, Biomaterials 26 (30), pp. 5927-5933, 2005a
7. Unsworth L D, Sheardown H and Brash J L. Protein resistance of surfaces prepared by sorption of end-thiolated poly(ethylene glycol) to gold: effect of surface chain density, Langmuir 21, pp. 1036-1041, 2005b.
8. Wisniewski, N. and M. Reichert, Methods for reducing biosensor membrane biofouling Colloids and Surfaces B: Biointerfaces, 2000. 18 (3-4): p. 197-219.
9. Yang X and Zhang G. Diffusion-Controlled Redox Cycling at Nanoscale Interdigitated Electrodes, Proceedings of the COMSOL Multiphysics Conference, 285-290, 2005.
10. Yang X and Zhang G. Effect of Electron Transfer Rate on the Electrochemical Process of Interdigitated Electrodes, Proceedings of the COMSOL Conference, 233-238, 2006.
11. Yang X and Zhang G. The Voltammetric Performance of Interdigitated Electrodes with Different Electron-Transfer Rate Constants, Sensors and Actuators B, 126, 624-631, 2007a.
12. Yang X and Zhang G. Simulating the Structure and Effect of the Electrical Double Layer at Nanometer Electrodes, Nanotechnology, 18, 335201, 1-9, 2007b.
13. Yang Y, Zhang S F, Kingston M A, Jones G, Wright G, Spencer S A, Glucose sensor with improved haemocompatibility. Biosensors and Bioelectronics, 15, 221-227, 2000.
14. Zhang J, Lima F H B, Shao M H et al. Platinum monolayer on nonnoble metal-noble metal core-shell nanoparticle electrocatalysts for O₂ reduction. J. Phys Chem B, 109, 22701-22704, 2005.
15. Zhang J, Mo Y, Vukmirovie et al. Platinum monolayer electrocatalysts for O2 reduction: Pt monolayer on Pd(111) and on carbon-supported Pd nanoparticles. J Phys Chem B. 108, 10955-10964, 2004.
16. Zhukovskt K V. Three dimensional model of oxygen transport in a porous diffuser of PEM fuel cell. AIChE Journal, 49, 12, 3029-3036, 2003.

The above references are herein incorporated by reference in their entirety.

What is claimed is:

1. A nanostructure-enhanced stereo-electrode comprising:
(a) a substantially flat support base;
(b) a plurality of porous nanostructures connected directly to the support base, said plurality of porous nanostructures being substantially vertical in orientation to the support base, and said plurality of porous nanostructures forming a three-dimensional surface.

2. The stereo-electrode of claim 1, wherein said nanostructures are nanopillars or nanotubes.

3. The stereo-electrode of claim 2, wherein said nanotubes are filled with an ion-conducting electrolyte.

4. The stereo-electrode of claim 3, wherein said electrolyte is selected from the group consisting of CsH₂SO₄, NaCl, Ag₂S, AgI, PbCl₂, RbAg₄I₅, and combinations thereof.

5. The stereo-electrode of claim 4, wherein said solid electrolyte is CsH₂SO₄.

6. The stereo-electrode of claim 1, wherein said nanostructures comprise a material capable of catalyzing a reduction/oxidation chemical transformation reaction.

7. The stereo-electrode of claim 6, wherein said material is selected from the group consisting of metal, metal oxide, alloy, and a combination thereof.

8. The stereo-electrode of claim 7, wherein said material is selected from the group consisting of platinum, palladium, rhodium, lead, and combinations thereof.

9. The stereo-electrode of claim 8, wherein said metal is platinum or an alloy thereof.

10. The stereo-electrode of claim 6, wherein said material utilizes a redox co-factor.

11. The stereo-electrode of claim 10, wherein said material is glucose oxidase.

12. An electrochemical conversion device comprising one or more stereo-electrodes, said stereo-electrodes comprising a plurality of porous nanotubes connected directly to a substantially flat support base, said plurality of porous nanotubes being substantially vertical in orientation to the support base, and said plurality of porous nanotubes are filled with an electrolyte, wherein said plurality of porous nanotubes form a three-dimensional surface.

13. The device of claim 12, wherein a first stereo-electrode is stacked on top of a second stereo-electrode, thereby forming a three-dimensional interconnected electrolytic network.

14. The device of claim 13, wherein said device is a fuel-cell.

15. A device comprising a nanostructure-enhanced stereo-electrode comprising:
(a) a substantially flat support base;
(b) an array of nanostructures connected directly to the support base, said plurality of nanostructures being substantially vertical in orientation to the support base, and said plurality of nanostructures forming a three-dimensional surface, wherein said surface is micropatterned.

16. The device of claim 15, wherein said structure is interdigitated.

17. The device of claim 15, wherein at least one of the nanostructure comprises a material capable of accelerating a reduction/oxidation chemical transformation.

18. The device of claim 17, wherein said material is selected from the group consisting of metal, metal oxide, and an alloy.

19. The device of claim 18, wherein said metal is selected from the group consisting of platinum, palladium, rhodium, lead, and alloys thereof.

20. The device of claim 19, wherein said material is an alloy of platinum and lead.

21. The device of claim 17, wherein said material utilizes a redox co-factor.

22. The device of claim 21, wherein said redox co-factor is FAD or NADH.

23. The device of claim 22, wherein said nanostructures comprise glucose oxidase.

24. The device of claim 15, wherein said device is a biosensor.

25. The device of claim 15, wherein at least one of the nanostructures is coated with self-assembled monolayer of inert molecules.

26. A microflow channel comprising an interdigitated array of microplanar electrodes, which comprises a first nanoelectrode, said first nanoelectrode comprising:
(a) a substantially flat support base;
(b) a plurality of nanostructures connected directly to the support base, said plurality of nanostructures being substantially vertical in orientation to the support base, and said plurality of nanostructures forming a three-dimensional surface; and
(c) a second nanoelectrode, said second nanoelectode being a nanoelectrode detector; wherein the interdigitated array comprises a detector:electrode repeat, wherein said repeat is repeated at least twice.

27. The microflow channel of claim 26, wherein said repeat is repeated at least three times.

28. A process for fabricating a porous nanostructure-enhanced stereo-electrode comprised of substantially vertical porous nanostructures, such process comprising:
(a) developing a nanoporous template by anodizing a metallic sheet;
(b) electrodepositing nanostructures onto said nanoporous template;
(c) pore forming on nanostructures by de-alloying;
(d) removing the template; and
(e) coating the outer layer of the nanostructures with a material capable of accelerating an oxidation/reduction chemical transformation.

29. The process of claim 28, wherein said nanostructures are nanotubes or nanopillars.

30. The process of claim 29, wherein prior to the removal of the template, the nanotubes are filled with an electrolyte.

31. The process of claim 30, further comprising a step of stacking two of the nanotubular structures on top of each other.

32. The process of claim 28, wherein said template is removed completely.

33. The process of claim 28, wherein said metallic sheet is selected from the group consisting of gold, silver, aluminum, titanium, platinum, copper, palladium, and combinations thereof.

34. The process of claim 33, wherein the metallic sheet is aluminum.

35. The process of claim 28, wherein said nanostructures are made by electrodeposition of a metal selected from the group consisting of gold, silver, platinum, copper, palladium, and alloys thereof.

36. The process of claim 35, wherein said nanostructures are made by electrodeposition of an alloy of gold and silver.
